(19) United States
(12) Patent Application Publication
(10) Pub. No.: US 2023/0250703 A1
(43) Pub. Date: Aug. 10, 2023

(54) EXPANDING METAL FOR CONTROL LINES

(71) Applicant: Halliburton Energy Services, Inc., Houston, TX (US)

(72) Inventor: Ryan David Mair, Aberdeenshire (GB)

(21) Appl. No.: 17/665,818

(22) Filed: Feb. 7, 2022

(51) Int. Cl. E21B 33/12; E21B 33/127

(52) U.S. Cl. CPC E21B 33/1208; E21B 33/1277

(57) ABSTRACT

Provided is a control line, a method for sealing a control line, and a well system including a control line. The control line, in one aspect, includes a control line tubular, the control line tubular having a length (Lₜ), a width (Wₜ) and wall thickness (Tₜ). The control line, in accordance with at least this aspect, further includes a sleeve of expandable metal positioned within the control line tubular, the sleeve of expandable metal comprising a metal configured to expand in response to hydrolysis to seal the control line tubular when contacting a reactive fluid.

### BACKGROUND

Statutory regulations require pressure isolation, among other things, across reservoir zones in a subterranean well during plug and abandonment of the well. In this context, wellbore tubulars through such permeable zones may be required to be pressure-isolated at both the outside and the inside of the particular wellbore tubular in the well.

### BRIEF DESCRIPTION

Reference is now made to the following descriptions taken in conjunction with the accompanying drawings, in which:

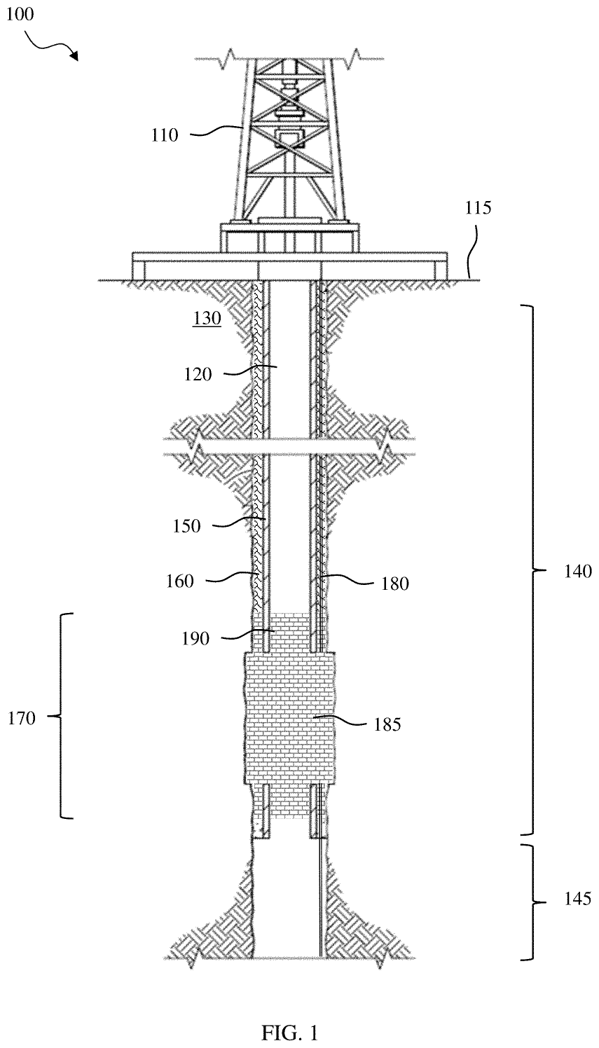

FIG. 1 depicts a well system including an exemplary operating environment that the apparatuses, systems and methods disclosed herein may be employed;

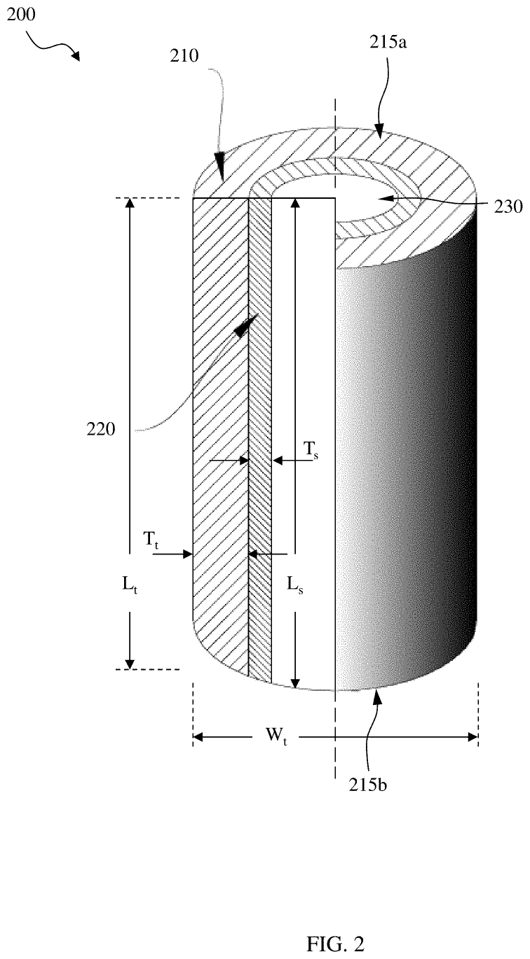

FIG. 2 depicts one embodiment of a control line designed, manufactured and operated according to one or more embodiments of the disclosure;

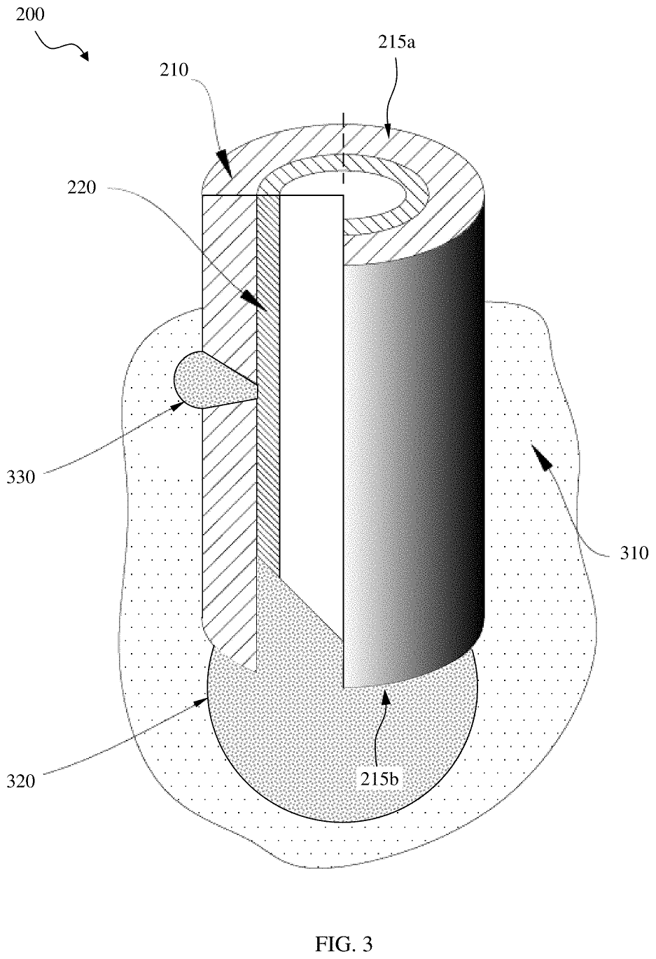

FIG. 3 depicts the control line of FIG. 2 after an exposed region of the sleeve of expandable metal is subjected to a reactive fluid to form an expanded metal seal in the control line tubular;

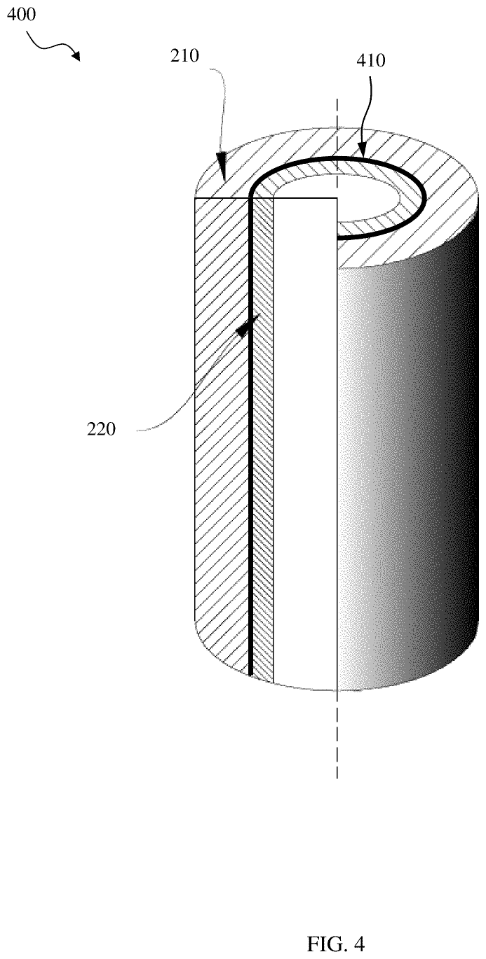

FIG. 4 depicts one embodiment of a control line designed, manufactured and operated according to one or more alternative embodiments of the disclosure;

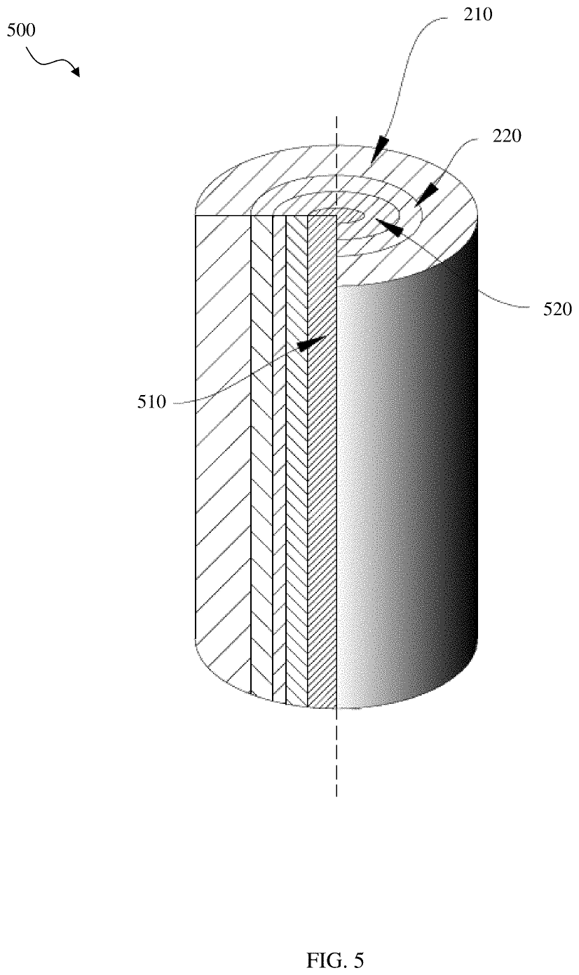

FIG. 5 depicts one embodiment of a control line designed, manufactured and operated according to one or more alternative embodiments of the disclosure;

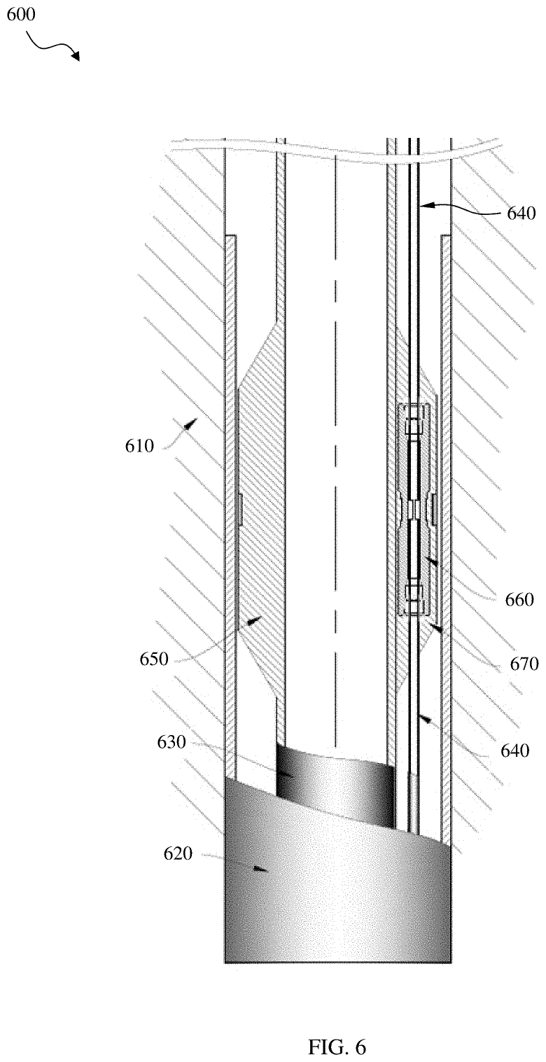

FIG. 6 depicts one embodiment of a well system designed, manufactured and operated according to one or more embodiments of the disclosure;

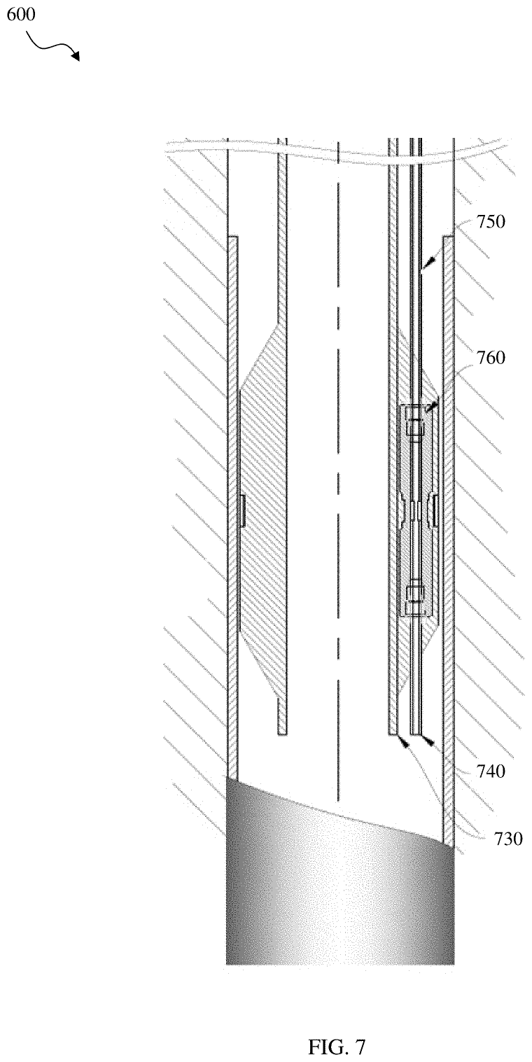

FIG. 7 depicts the well system of FIG. 6 after the wellbore tubular and the control line have been severed, for example during a conventional plug and abandonment application; and

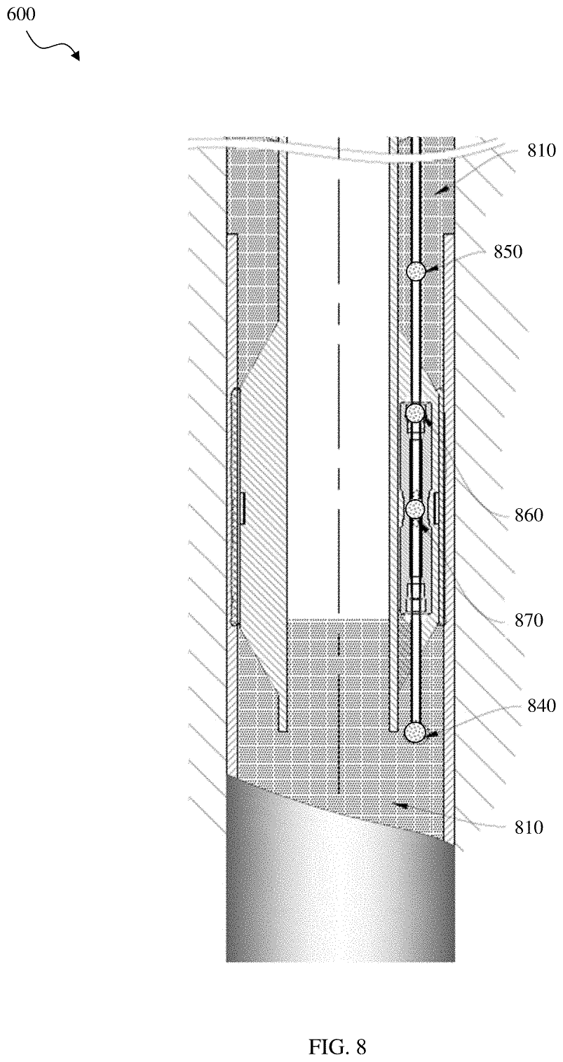

FIG. 8 depicts the well system of FIG. 7 after subjecting one or more of the exposed end of the control line, the crack or anomaly, and/or the leak to a reactive fluid to form one or more expanded metal seals in the control line tubular.

### DETAILED DESCRIPTION

In the drawings and descriptions that follow, like parts are typically marked throughout the specification and drawings with the same reference numerals, respectively. The drawn figures are not necessarily to scale. Certain features of the disclosure may be shown exaggerated in scale or in somewhat schematic form and some details of certain elements may not be shown in the interest of clarity and conciseness. The present disclosure may be implemented in embodiments of different forms.

Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed herein may be employed separately or in any suitable combination to produce desired results.

Unless otherwise specified, use of the terms “connect,” “engage,” “couple,” “attach,” or any other like term describing an interaction between elements is not meant to limit the interaction to a direct interaction between the elements and may also include an indirect interaction between the elements described. Unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of a well, regardless of the wellbore orientation. Use of any one or more of the foregoing terms shall not be construed as denoting positions along a perfectly vertical axis. Unless otherwise specified, use of the term “subterranean formation” shall be construed as encompassing both areas below exposed earth and areas below earth covered by water such as ocean or fresh water.

Many of today's subterranean wells, particularly intelligent completions, employ one or more control lines that run alongside the wellbore tubular, often in an annulus between the wellbore tubular and the wellbore. Unfortunately, traditional plugging and abandonment techniques employing cement have difficulties sealing the control lines. As such, fluid/gas can later migrate though the control lines from the wellbore and/or reservoir to the surface since the control lines can be vertical leak paths through the cement barriers.

Based at least in part upon the foregoing, the present disclosure has envisioned using expandable metal as part of the control lines and/or the overall control line system to prevent undesired fluid communication (e.g., from within the control line) when the expandable metal is intentionally or accidently exposed to certain reactive fluids. For example, the expandable metal can react when unexpectedly exposed to a reactive fluid (e.g., ocean water) to self-plug the affected control line and prevent hydrocarbons contaminating the seabed. In an alternative embodiment, control lines downhole can be intentionally exposed to a specific reactive fluid (e.g., brine) to create control line barriers at specific places in the control line system. This can be used in place of, or in conjunction with typical cementing or traditional plugging methods to provide a more reliable method of placing barriers in the control line system. Another benefit of expandable metal used in the control line system is to self-heal and plug control line leaks that occur downhole, ultimately reducing workovers and increase the robustness of the downhole system.

Referring to FIG. 1, depicted is a well system 100 including an exemplary operating environment that the apparatuses, systems and methods disclosed herein may be employed. For example, the well system 100 could include a control line 180 according to any of the embodiments, aspects, applications, variations, designs, etc. disclosed in the following paragraphs. As depicted, the well system 100 includes a workover and/or drilling rig 110 that is positioned above the earth's surface 115 and extends over and around a wellbore 120 that penetrates a subterranean formation 130 for the purpose of recovering hydrocarbons. The subterranean formation 130 may be located below exposed earth, as shown, as well as areas below earth covered by water, such as ocean or fresh water. In fact, many aspects of the present disclosure are particularly suited for subterranean formations 130 located below the earth covered by water. As those skilled in the art appreciate, the wellbore 120 may be fully cased, partially cased, have multiple concentric wellbore tubulars, or an open hole wellbore. The casing may also be a liner that extends partway to the surface. In the illustrated embodiment of FIG. 1, the wellbore 120 is partially cased, and thus includes a cased region 140 and an open hole region 145.

The wellbore 120 may be drilled into the subterranean formation 130 using any suitable drilling technique. In the example illustrated in FIG. 1, the wellbore 120 extends substantially vertically away from the earth's surface 115. Notwithstanding, in other embodiments the wellbore 120 could include a vertical wellbore portion, deviate from vertical relative to the earth's surface 115 over a deviated wellbore portion, and then transition to a horizontal wellbore portion. In alternative operating environments, all or portions of a wellbore 120 may be vertical, deviated at any suitable angle, horizontal, and/or curved. The wellbore 120 may be a new wellbore, an existing wellbore, a straight wellbore, an extended reach wellbore, a sidetracked wellbore, a multi-lateral wellbore, or any other type of wellbore for drilling, completing, and/or the production of one or more zones. Further, the wellbore 120 may be used for both producing wells and injection wells.

In accordance with the disclosure, the wellbore 120 may include a wellbore tubular 150. The wellbore tubular 150, in the illustrated embodiment of FIG. 1, is wellbore casing that is held in place by cement 160 in the cased region 140. In alternative embodiments, the wellbore tubular 150 is production tubing, a liner, the wellbore itself, or any other type of tubular that might be located within a wellbore. In particular, a wellbore tubular includes any tubular having an annulus that surrounds it, as might be found with a concentric set of wellbore tubulars. While the wellbore tubular 150 is illustrated in FIG. 1 as being located in the cased region 140, other embodiments exist wherein the wellbore tubular 150 is located in the open hole region 145.

In the illustrated embodiment of FIG. 1, a longitudinal section of the wellbore tubular 150 has been removed proximate a plug and abandonment section 170 of the well system 100. The plug and abandonment section 170 of the well system 100 need not be a permanent plug and abandonment, but could be a temporary plug and abandonment, for example using a bridge plug or other temporary abandonment structure. Further to the embodiment of FIG. 1, the wellbore 120 in the plug and abandonment section 170 has been diametrically enlarged. Accordingly, in the embodiment of FIG. 1 a diameter of the wellbore 120 in the plug and abandonment section 170 is larger than a diameter of the wellbore 120 directly above and below the plug and abandonment section 170. Further to the embodiment of FIG. 1, the cement 160 in the annulus surrounding the wellbore tubular 150 has been removed a short distance above and below the plug and abandonment section 170. In the illustrated embodiment, a plug material 185, such as cement, substantially fills the plug and abandonment section 170.

Further to the embodiment of FIG. 1, the well system 100 includes the control line 180. For example, the control line 180 might extend within the wellbore 120 from the surface 115. In the illustrated embodiment, the control line 180 has been severed above and below the plug and abandonment section 170, for example at the same time the longitudinal section of the wellbore tubular 150 was formed. Nevertheless, the control line 180 may be severed at many other locations within wellbore 120, whether that be above or below the plug and abandonment section 170. In accordance with one or more aspects of the disclosure, the control line 180 includes a control line tubular, the control line tubular having a length (Lₜ), a width (Wₜ) and wall thickness (Tₜ) (e.g., as shown in FIG. 2 discussed below). In accordance with one or more aspects of the disclosure, the control line 180 further includes a sleeve of expandable metal positioned within the control line tubular, the sleeve of expandable metal comprising a metal configured to expand in response to hydrolysis to seal the control line tubular when contacting a reactive fluid. When the metal configured to expand in response to hydrolysis contacts the reactive fluid, an expanded metal seal (e.g., sealing at least a portion of the control line tubular) is formed.

The term expandable metal, as used herein, refers to the expandable metal in a pre-expansion form. Similarly, the term expanded metal, as used herein, refers to the resulting expanded metal after the expandable metal has been subjected to reactive fluid, as discussed below. The expanded metal, in accordance with one or more aspects of the disclosure, comprises a metal that has expanded in response to hydrolysis. In certain embodiments, the expanded metal includes residual unreacted metal. For example, in certain embodiments the expanded metal is intentionally designed to include the residual unreacted metal. The residual unreacted metal has the benefit of allowing the expanded metal to self-heal if cracks or other anomalies subsequently arise, or for example to accommodate changes in the tubular or mandrel diameter due to variations in temperature and/or pressure. Nevertheless, other embodiments may exist wherein no residual unreacted metal exists in the expanded metal.

The expandable metal, in some embodiments, may be described as expanding to a cement like material. For example, the expandable metal may go from metal to micron-scale particles and then these particles expand and lock together to, in essence, seal two or more surfaces together. The reaction may, in certain embodiments, occur in less than 2 days in a reactive fluid and in certain temperatures. Nevertheless, the time of reaction may vary depending on the reactive fluid, the expandable metal used, the downhole temperature, and surface-area-to-volume ratio (SA:V) of the expandable metal.

In some embodiments, the reactive fluid may be a brine solution such as may be produced during well completion activities, and in other embodiments, the reactive fluid may be one of the additional solutions discussed herein, including ocean water, wellbore fluid, etc. The expandable metal is electrically conductive in certain embodiments. The expandable metal, in certain embodiments, has a yield strength greater than about 2,000 psi, e.g., 2,000 psi +/−50%. In yet another embodiment, the expandable metal has a yield strength greater than about 8,000 psi, e.g., 8,000 psi +/−50%. In even yet another embodiment, the expandable metal has a yield strength greater than about 15,000 psi, e.g., 15,000 psi +/−50%.

The hydrolysis of the expandable metal can create a metal hydroxide. The formative properties of alkaline earth metals (Mg—Magnesium, Ca—Calcium, etc.) and transition metals (Zn—Zinc, Al—Aluminum, etc.) under hydrolysis reactions demonstrate structural characteristics that are favorable for use with the present disclosure. Hydration results in an increase in size from the hydration reaction and results in a metal hydroxide that can precipitate from the fluid.

The hydration reactions for magnesium is:

Mg+2H₂O→Mg(OH)₂+H₂,

where Mg(OH)₂ is also known as brucite. Another hydration reaction uses aluminum hydrolysis. The reaction forms a material known as Gibbsite, bayerite, boehmite, aluminum oxide, and norstrandite, depending on form. The possible hydration reactions for aluminum are:

Al+3H₂O→Al(OH)₃+3/2H₂.

Al+2H₂O→Al O(OH)+3/2H₂

Al+3/2H₂O→½Al₂O₃+3/2H₂

Another hydration reaction uses calcium hydrolysis. The hydration reaction for calcium is:

Ca+2H₂O→Ca(OH)₂+H₂,

Where Ca(OH)₂ is known as portlandite and is a common hydrolysis product of Portland cement. Magnesium hydroxide and calcium hydroxide are considered to be relatively insoluble in water. Aluminum hydroxide can be considered an amphoteric hydroxide, which has solubility in strong acids or in strong bases. Alkaline earth metals (e.g., Mg, Ca, etc.) work well for the expandable metal, but transition metals (Al, etc.) also work well for the expandable metal. In one embodiment, the metal hydroxide is dehydrated by the swell pressure to form a metal oxide.

In at least one embodiment, the expandable metal is a non-graphene based expandable metal. By non-graphene based material, it is meant that is does not contain graphene, graphite, graphene oxide, graphite oxide, graphite intercalation, or in certain embodiments, compounds and their derivatized forms to include a function group, e.g., including carboxy, epoxy, ether, ketone, amine, hydroxy, alkoxy, alkyl, aryl, aralkyl, alkaryl, lactone, functionalized polymeric or oligomeric groups, or a combination comprising at least one of the forgoing functional groups. In at least one other embodiment, the expandable metal does not include a matrix material or an exfoliatable graphene-based material. By not being exfoliatable, it is meant that the expandable metal is not able to undergo an exfoliation process. Exfoliation as used herein refers to the creation of individual sheets, planes, layers, laminae, etc. (generally, “layers”) of a graphene-based material; the delamination of the layers; or the enlargement of a planar gap between adjacent ones of the layers, which in at least one embodiment the expandable metal is not capable of.

In yet another embodiment, the expandable metal does not include graphite intercalation compounds, wherein the graphite intercalation compounds include intercalating agents such as, for example, an acid, metal, binary alloy of an alkali metal with mercury or thallium, binary compound of an alkali metal with a Group V element (e.g., P, As, Sb, and Bi), metal chalcogenide (including metal oxides such as, for example, chromium trioxide, PbO₂, MnO₂, metal sulfides, and metal selenides), metal peroxide, metal hyperoxide, metal hydride, metal hydroxide, metals coordinated by nitrogenous compounds, aromatic hydrocarbons (benzene, toluene), aliphatic hydrocarbons (methane, ethane, ethylene, acetylene, n-hexane) and their oxygen derivatives, halogen, fluoride, metal halide, nitrogenous compound, inorganic compound (e.g., trithiazyl trichloride, thionyl chloride), organometallic compound, oxidizing compound (e.g., peroxide, permanganate ion, chlorite ion, chlorate ion, perchlorate ion, hypochlorite ion, As₂O₅, N₂O₅, CH₃ClO₄, (NH₄)₂S₂O₈, chromate ion, dichromate ion), solvent, or a combination comprising at least one of the foregoing. Thus, in at least one embodiment, the expandable metal is a structural solid expanded metal, which means that it is a metal that does not exfoliate and it does not intercalate. In yet another embodiment, the expandable metal does not swell by sorption.

In an embodiment, the expandable metal used can be a metal alloy. The expandable metal alloy can be an alloy of the base expandable metal with other elements in order to either adjust the strength of the expandable metal alloy, to adjust the reaction time of the expandable metal alloy, or to adjust the strength of the resulting metal hydroxide byproduct, among other adjustments. The expandable metal alloy can be alloyed with elements that enhance the strength of the metal such as, but not limited to, Al—Aluminum, Zn—Zinc, Mn—Manganese, Zr—Zirconium, Y—Yttrium, Nd—Neodymium, Gd—Gadolinium, Ag—Silver, Ca—Calcium, Sn—Tin, and Re—Rhenium, Cu—Copper. In some embodiments, the expandable metal alloy can be alloyed with a dopant that promotes corrosion, such as Ni—Nickel, Fe—Iron, Cu—Copper, Co—Cobalt, Ir—Iridium, Au—Gold, C—Carbon, Ga—Gallium, In—Indium, Mg—Mercury, Bi—Bismuth, Sn—Tin, and Pd—Palladium. The expandable metal alloy can be constructed in a solid solution process where the elements are combined with molten metal or metal alloy. Alternatively, the expandable metal alloy could be constructed with a powder metallurgy process. The expandable metal can be cast, forged, extruded, sintered, welded, mill machined, lathe machined, stamped, eroded or a combination thereof. The metal alloy can be a mixture of the metal and metal oxide. For example, a powder mixture of aluminum and aluminum oxide can be ball-milled together to increase the reaction rate.

Optionally, non-expanding components may be added to the starting metallic materials. For example, ceramic, elastomer, plastic, epoxy, glass, or non-reacting metal components can be embedded in the expandable metal or coated on the surface of the expandable metal. In yet other embodiments, the non-expanding components are metal fibers, a composite weave, a polymer ribbon, or ceramic granules, among others. Alternatively, the starting expandable metal may be the metal oxide. For example, calcium oxide (CaO) with water will produce calcium hydroxide in an energetic reaction. Due to the higher density of calcium oxide, this can have a 260% volumetric expansion (e.g., converting 1 mole of CaO may cause the volume to increase from 9.5cc to 34.4cc). In one variation, the expandable metal is formed in a serpentinite reaction, a hydration and metamorphic reaction. In one variation, the resultant material resembles a mafic material. Additional ions can be added to the reaction, including silicate, sulfate, aluminate, carbonate, and phosphate. The metal can be alloyed to increase the reactivity or to control the formation of oxides.

The expandable metal can be configured in many different fashions, as long as an adequate volume of material is available for sealing the leak. For example, the expandable metal may be formed into a single long member, multiple short members, rings, among others. In at least one embodiment, the control line tubular has a length (Lₜ) between exposed ends, the sleeve of expandable metal has a length (Lₛ), and the length (Lₛ) is at least 25% of the length (Lₜ). In yet another embodiment, the length (Lₛ) is at least 50% of the length (Lₜ). In even yet another embodiment, the length (Lₛ) is at least 75% of the length (Lₜ), or even at least 90%. In one optional embodiment, the length (Lₛ) is equal to the length (Lₜ). (See, for example, the control line tubular 210 and the sleeve of expandable metal 200 illustrated in the embodiment of FIG. 2).

Additionally, a barrier layer may be applied to one or more portions of the expandable metal to delay the expanding reactions. For example, the barrier layer could be positioned between the control line tubular and the sleeve of expandable metal. In yet another embodiment, the barrier layer coats an inside surface of the sleeve of expandable metal. In one embodiment, the material configured to delay the hydrolysis process is a fusible alloy. In another embodiment, the material configured to delay the hydrolysis process is a eutectic material. In yet another embodiment, the material configured to delay the hydrolysis process is a wax, oil, or other non-reactive material.

The well system 100 illustrated in the embodiment of FIG. 1 may additionally include a cement plug 190. The cement plug 190, in certain embodiments, is employed to plug the wellbore tubular 150, whereas the sleeve of expandable metal is configured to plug the control line 180.

Turning to FIG. 2, illustrated is one embodiment of a control line 200 designed, manufactured and operated according to one or more embodiments of the disclosure. The control line 200, in accordance with one embodiment of the disclosure, includes a control line tubular 210. The control line tubular 210, in the illustrated embodiment, has a length (Lₜ) (e.g., between exposed ends 215a, 215b), a width (Wₜ) and wall thickness (Tₜ). In at least one embodiment, the length (Lₜ) of the control line tubular 210 is at least 4 cm. In at least one other embodiment, the length (Lₜ) of the control line tubular 210 is at least 5 m. In at least an additional embodiment, the length (Lₜ) of the control line tubular 210 is at least 20 m, and in yet another embodiment at least 100 m. In yet another embodiment, the length (Lₜ) of the control line tubular 210 is at least 1000 m.

Additionally, in at least one embodiment, the width (Wₜ) of the control line tubular 210 is no greater than 50 mm. In another embodiment, the width (Wₜ) of the control line tubular 210 is no greater than 26 mm, and in yet another embodiment no greater than 13 mm. Additionally, in at least one embodiment, the wall thickness (Tₜ) of the control line tubular 210 is no greater than 6 mm. In another embodiment, the wall thickness (Tₜ) of the control line tubular 210 is no greater than 3 mm, and in yet another embodiment no greater than 1 mm.

The control line tubular 210 may comprise many different shapes and remain within the scope of the disclosure. In at least one embodiment, however, a cross-sectional shape of the control line tubular 210 is circular or oval. Notwithstanding, a polygonal or other cross-sectional shape is within the scope of the disclosure.

The control line tubular 210 may additionally comprise many different materials and remain within the scope of the disclosure. In at least one embodiment, the control line tubular 210 comprises a metal, such as nickel alloy, stainless steel, aluminum, copper, etc. In yet another embodiment, the control line tubular 210 comprises a composite material, or any other known or hereafter discovered material that might be used for the control line tubular 210.

The control line 200, in accordance with the disclosure, may additionally include a sleeve of expandable metal 220 positioned within the control line tubular 210. The sleeve of expandable metal 220, in the illustrated embodiment, comprises a metal configured to expand in response to hydrolysis to seal the control line tubular 210 when contacting a reactive fluid. The expandable metal, in certain embodiments, comprises one or more of the metals discussed in the paragraphs above.

The sleeve of expandable metal 220, in the illustrated embodiment, has a length (Lₛ) (e.g., between exposed ends 215a, 215b) and wall thickness (Tₛ). In at least one embodiment, the length (Lₛ) of the sleeve of expandable metal 220 is at least 3 cm. In at least one other embodiment, the length (Lₛ) of the sleeve of expandable metal 220 is at least 4 m, and in yet another embodiment at least 15 m, if not at least 75 m. In yet another embodiment, the length (Lₛ) of the sleeve of expandable metal 220 is at least 1000 m. For example, in at least one embodiment the length (Lₛ) is at least 25% of the length (Lₜ). In yet another embodiment, the length (Lₛ) is at least 50% of the length (Lₜ). In even yet another embodiment, the length (Lₛ) is at least 75% of the length (Lₜ), or even at least 90%. In one optional embodiment, the length (Lₛ) is equal to the length (Lₜ). Additionally, in at least one embodiment, the wall thickness (Tₛ) of the sleeve of expandable metal 220 is no greater than 10 mm. In another embodiment, the wall thickness (Tₛ) of the sleeve of expandable metal 220 is no greater than 3 mm, and in yet another embodiment no greater than 1 mm.

In at least one embodiment, such as shown in FIG. 2, the sleeve of expandable metal 220 forms a passageway 230 (e.g., fluid passageway) within the control line tubular 210. In other embodiments, other features are located inside of the sleeve of expandable metal 220, or alternatively, the sleeve of expandable metal 220 does not form the passageway 230.

Turning to FIG. 3, illustrated is the control line 200 of FIG. 2 after an exposed region of the sleeve of expandable metal 220 is subjected to a reactive fluid 310 to form an expanded metal seal in the control line tubular 210. Any of the reactive fluids discussed above could be used for the reactive fluid 310. In at least one embodiment, the exposed region of the sleeve of expandable metal 220 is intentionally subjected to the reactive fluid, such is the case when the control line tubular 210 is intentionally severed and exposed to the reactive fluid 310. In yet another embodiment, the sleeve of expandable metal 220 is unexpectedly subjected to the reactive fluid, such is the case when a crack or anomaly in the control line tubular 210 forms and the crack or anomaly is unexpectedly subjected to the reactive fluid 310.

In the illustrated embodiment of FIG. 3, one or more of the exposed ends 215a, 215b of the control line tubular 210, and thus the sleeve of expandable metal 220, is exposed to the reactive fluid 310, thereby forming an expanded metal seal 320 at one or more of the exposed ends 215a, 215b. In at least one embodiment, the expanded metal seal 320 extends at least partially within the control line tubular 210, such as shown. In yet another embodiment, the expanded metal seal 320 does not extend into the control line tubular 210, but essentially forms a capped expanded metal seal 320 over and around one or more of the exposed ends 215a, 215b.

Further to the embodiment of FIG. 3, a crack or anomaly may form in the control line tubular 210, resulting in an expanded metal seal 330 filling or otherwise sealing the crack or anomaly. In at least one embodiment, such as shown, the crack or anomaly is formed in a side surface of the control line tubular 210. Moreover, while a single crack or anomaly and single expanded metal seal 330 is illustrated as formed in the side surface of the control line tubular 210, any number of cracks or anomalies may be sealed by the sleeve of expandable metal 220. Moreover, unreacted expandable metal may be used to self-heal the crack or anomalies if they were to subsequently leak and/or grow.

Turning to FIG. 4, illustrated is one embodiment of a control line 400 designed, manufactured and operated according to one or more alternative embodiments of the disclosure. The control line 400 is similar in certain respects to the control line 200 of FIG. 2. Accordingly, like reference numbers have been used to illustrate similar, if not substantially identical, features. The control line 400 differs, for the most part, from the control line 200, in that the control line 400 additionally includes a barrier layer 410. The barrier layer 410 may comprise any of the materials discussed above, and thus may prevent and/or retard a reactive fluid from contacting the sleeve of expandable metal 220. Additionally, while the barrier layer 410 is positioned between the control line tubular 210 and the sleeve of expandable metal 220 in embodiment of FIG. 4, other embodiments exist wherein the barrier layer 410 is located inside of the sleeve of expandable metal 220, among other locations.

Turning to FIG. 5, illustrated is one embodiment of a control line 500 designed, manufactured and operated according to one or more alternative embodiments of the disclosure. The control line 500 is similar in certain respects to the control line 200 of FIG. 2. Accordingly, like reference numbers have been used to illustrate similar, if not substantially identical, features. The control line 500 differs, for the most part, from the control line 200, in that the control line 500 additionally includes an electric communication line or optical fiber communication line 510 placed within the control line tubular 210. Any electric communication line or optical fiber communication line currently known or hereafter discovered could be used with the control line 500 of FIG. 5. Furthermore, in at least one embodiment, a sleeve of filler material 520 may be placed within the control line tubular 210, for example between the sleeve of expandable metal 220 and the electric communication line or optical fiber communication line 510. Those skilled in the art understand the different materials that the sleeve of filler material 520 may comprise and remain within the scope of the disclosure.

Turning to FIG. 6, illustrated is one embodiment of a well system 600 designed, manufactured and operated according to one or more embodiments of the disclosure. The well system 600, in the illustrated embodiment, could be similar to the well system 100 described above with regard to FIG. 1. Accordingly, in the embodiment of FIG. 6, the well system 600 includes wellbore casing 620 located within a subterranean formation 610, as well as a wellbore tubular 630 positioned radially inside of the wellbore casing 620. In at least one embodiment, the wellbore tubular 630 is production tubing. The well system 600 of FIG. 6 additionally includes one or more control lines 640 designed, manufactured and operated according to one or more aspects of the disclosure. Accordingly, in at least one embodiment, the one or more control lines 640 may each include a control line tubular and a sleeve of expandable metal.

The well system 600 of FIG. 6 may additionally include a splice clamp 650. For example, the splice clamp 650 could be used to couple the one or more control lines 640 together. In at least one embodiment, the splice clamp 650 includes a splice bulkhead 660, as well as one or more connectors 670 for coupling the one or more control lines 640 to the splice bulkhead 660. In at least one embodiment, the control line tubular of the one or more control lines 640 form at least a portion of the control line splice configuration (e.g., one or more of the splice clamp 650, the splice bulkhead 660 and/or the one or more connectors 670), which is configured to couple the control lines 640 together. Accordingly, the sleeve of expandable metal, as described above, may be used to seal leaks anywhere along the one or more control lines 640, including when the one or more control lines are severed, cracks or anomalies in a sidewall of the one or more control lines 640 form, a leak in the splice clamp 650 forms, a leak in the splice bulkhead 660 forms, as well as a leak at the one or more connectors 670 forms.

Turning to FIG. 7, illustrated is the well system 600 of FIG. 6 after the wellbore tubular 630 and the control line 640 have been severed, for example during a conventional plug and abandonment application. What results, in the illustrated embodiment, are an exposed end 730 of the wellbore tubular 630 and exposed end 740 of the control line 640. Further to the embodiment of FIG. 7, a crack or anomaly 750 has formed in the control line 640 and/or a leak 760 has formed at one or more of the connectors 670 (e.g., a loose or damages connection at the one or more connectors 670). It should be noted that while the embodiment of FIG. 7 illustrates the control line 640 being severed at a single location, other embodiments may exist wherein the control line 640 is severed at two or more different locations.

Turning to FIG. 8, illustrated is the well system 600 of FIG. 7 after subjecting one or more of the exposed end 740 of the control line 640, the crack or anomaly 750, and/or the leak 760 to a reactive fluid to form one or more expanded metal seals in the control line tubular. What ultimately results, is a sealed control line 810. In the illustrated embodiment of FIG. 8, the exposed end 740 forms a capped expanded metal seal 840, the crack or anomaly 750 forms an expanded metal seal 850 filling or otherwise sealing the crack or anomaly 750, and the leak 760 forms an expanded metal seal 860 sealing the one or more connectors 670. In at least one other embodiment, the reactive fluid makes its way into the splice bulkhead 660 to form an expanded metal seal 870 therein. Unique to one aspect of the present disclosure, the sleeve of expandable metal allows for and can accommodate substantially any leak at any location in the control line 640.

Aspects Disclosed Herein Include:

A. A control line for use in a well system, the control line including: 1) a control line tubular, the control line tubular having a length (Lₜ), a width (Wₜ) and wall thickness (Tₜ); and 2) a sleeve of expandable metal positioned within the control line tubular, the sleeve of expandable metal comprising a metal configured to expand in response to hydrolysis to seal the control line tubular when contacting a reactive fluid

B. A method for sealing a control line, the method including: 1) positioning a control line within a wellbore located in a subterranean formation, the control line including: a) a control line tubular, the control line tubular having a length (Lₜ), a width (Wₜ) and wall thickness (Tₜ); and b) a sleeve of expandable metal positioned within the control line tubular, the sleeve of expandable metal comprising a metal configured to expand in response to hydrolysis; and 2) subjecting an exposed region of the sleeve of expandable metal to a reactive fluid to form an expanded metal seal in the control line tubular.

C. A well system, the well system including: 1) a wellbore located within a subterranean formation; and 2) a control line located in the wellbore, the control line including: a) a control line tubular, the control line tubular having a length (Lₜ), a width (Wₜ) and wall thickness (Tₜ); and b) a sleeve of expandable metal positioned within the control line tubular, the sleeve of expandable metal comprising a metal configured to expand in response to hydrolysis to seal the control line tubular when contacting a reactive fluid.

Aspects A, B, and C may have one or more of the following additional elements in combination: Element 1: further including a barrier layer positioned between the control line tubular and the sleeve of expandable metal. Element 2: further including an electric communication line or optical fiber communication line placed within the control line tubular and the sleeve of expandable metal. Element 3: further including a sleeve of filler material placed within the control line tubular and the sleeve of expandable metal. Element 4: wherein the sleeve of filler material is positioned between the sleeve of expandable metal and the electric communication line or optical fiber communication line. Element 5: wherein the length (Lₜ) of the control line tubular is at least 4 cm, the width (Wₜ) of the control line tubular is no greater than 50 mm, and the wall thickness (Tₜ) of the control line tubular is no greater than 6 mm. Element 6: wherein the sleeve of expandable metal has a length (Lₛ) and wall thickness (Tₛ), and further wherein the length (Lₛ) is at least 3 cm, and the wall thickness (Tₛ) is no greater than 10 mm. Element 7: wherein the length (Lₛ) is at least 75% of the length (Lₜ). Element 8: wherein the length (Lₛ) is at least 90% of the length (Lₜ). Element 9: wherein the wall thickness (Tₛ) of the sleeve of expandable metal is no greater than 3 mm. Element 10: wherein the control line tubular forms at least a portion of a control line splice configured to couple two separate control lines together. Element 11: further including a wellbore tubular located within the wellbore, the control line positioned in an annulus between the wellbore tubular and the wellbore, and further including severing the wellbore tubular and the control line tubular during a plug and abandonment application, the severing creating the exposed region, and further wherein the expanded metal seal seals the control line tubular. Element 12: wherein a crack in the control line forms the exposed region, the expanded metal seal sealing the crack in the control line. Element 13: wherein subjecting the exposed region of the sleeve of expandable metal to the reactive fluid includes intentionally subjecting the exposed region of the sleeve of expandable metal to the reactive fluid. Element 14: wherein subjecting the exposed region of the sleeve of expandable metal to the reactive fluid includes unexpectedly subjecting the exposed region of the sleeve of expandable metal to the reactive fluid. Element 15: further including a wellbore tubular located in the wellbore, the control line located in an annulus between the wellbore tubular and the wellbore. Element 16: further including an electric communication line or optical fiber communication line placed within the control line tubular and the sleeve of expandable metal. Element 17: further including a sleeve of filler material placed within the control line tubular and the sleeve of expandable metal. Element 18: wherein the sleeve of filler material is positioned between the sleeve of expandable metal and the electric communication line or optical fiber communication line. Element 19: wherein the length (Lₜ) of the control line tubular is at least 4 cm, the width (Wₜ) of the control line tubular is no greater than 50 mm, and the wall thickness (Tₜ) of the control line tubular is no greater than 6 mm. Element 20: wherein the sleeve of expandable metal has a length (Lₛ) and wall thickness (Tₛ), and further wherein the length (Lₛ) is at least 3 cm, and the wall thickness (Tₛ) is no greater than 10 mm. Element 21: wherein the length (Lₛ) is at least 75% of the length (Lₜ). Element 22: wherein the length (Lₛ) is at least 90% of the length (Lₜ). Element 23: wherein the wall thickness (Tₛ) of the sleeve of expandable metal is no greater than 3 mm. Element 24: wherein the control line tubular forms at least a portion of a control line splice configured to couple two separate control lines together.

Those skilled in the art to which this application relates will appreciate that other and further additions, deletions, substitutions and modifications may be made to the described embodiments.

What is claimed is:

1. A control line for use in a well system, comprising:
a control line tubular, the control line tubular having a length (Lₜ), a width (Wₜ) and wall thickness (Tₜ); and
a sleeve of expandable metal positioned within the control line tubular, the sleeve of expandable metal comprising a metal configured to expand in response to hydrolysis to seal the control line tubular when contacting a reactive fluid.

2. The control line as recited in claim 1, further including a barrier layer positioned between the control line tubular and the sleeve of expandable metal.

3. The control line as recited in claim 1, further including an electric communication line or optical fiber communication line placed within the control line tubular and the sleeve of expandable metal.

4. The control line as recited in claim 3, further including a sleeve of filler material placed within the control line tubular and the sleeve of expandable metal.

5. The control line as recited in claim 4, wherein the sleeve of filler material is positioned between the sleeve of expandable metal and the electric communication line or optical fiber communication line.

6. The control line as recited in claim 1, wherein the length (Lₜ) of the control line tubular is at least 4 cm, the width (Wₜ) of the control line tubular is no greater than 50 mm, and the wall thickness (Tₜ) of the control line tubular is no greater than 6 mm.

7. The control line as recited in claim 6, wherein the sleeve of expandable metal has a length (Lₛ) and wall thickness (Tₛ), and further wherein the length (Lₛ) is at least 3 cm, and the wall thickness (Tₛ) is no greater than 10 mm.

8. The control line as recited in claim 7, wherein the length (Lₛ) is at least 75% of the length (Lₜ).

9. The control line as recited in claim 7, wherein the length (Lₛ) is at least 90% of the length (Lₜ).

10. The control line as recited in claim 7, wherein the wall thickness (Tₛ) of the sleeve of expandable metal is no greater than 3 mm.

11. The control line a recited in claim 1, wherein the control line tubular forms at least a portion of a control line splice configured to couple two separate control lines together.

12. A method for sealing a control line, comprising:
positioning a control line within a wellbore located in a subterranean formation, the control line including:
a control line tubular, the control line tubular having a length (Lₜ), a width (Wₜ) and wall thickness (Tₜ); and
a sleeve of expandable metal positioned within the control line tubular, the sleeve of expandable metal comprising a metal configured to expand in response to hydrolysis; and
subjecting an exposed region of the sleeve of expandable metal to a reactive fluid to form an expanded metal seal in the control line tubular.

13. The method as recited in claim 12, further including a wellbore tubular located within the wellbore, the control line positioned in an annulus between the wellbore tubular and the wellbore, and further including severing the wellbore tubular and the control line tubular during a plug and abandonment application, the severing creating the exposed region, and further wherein the expanded metal seal seals the control line tubular.

14. The method as recited in claim 12, wherein a crack in the control line forms the exposed region, the expanded metal seal sealing the crack in the control line.

15. The method as recited in claim 12, wherein subjecting the exposed region of the sleeve of expandable metal to the reactive fluid includes intentionally subjecting the exposed region of the sleeve of expandable metal to the reactive fluid.

16. The method as recited in claim 12, wherein subjecting the exposed region of the sleeve of expandable metal to the reactive fluid includes unexpectedly subjecting the exposed region of the sleeve of expandable metal to the reactive fluid.

17. A well system, comprising:
a wellbore located within a subterranean formation; and
a control line located in the wellbore, the control line including:
a control line tubular, the control line tubular having a length (Lₜ), a width (Wₜ) and wall thickness (Tₜ); and
a sleeve of expandable metal positioned within the control line tubular, the sleeve of expandable metal comprising a metal configured to expand in response to hydrolysis to seal the control line tubular when contacting a reactive fluid.

18. The well system as recited in claim 17, further including a wellbore tubular located in the wellbore, the control line located in an annulus between the wellbore tubular and the wellbore.

19. The well system as recited in claim 17, further including an electric communication line or optical fiber communication line placed within the control line tubular and the sleeve of expandable metal.

20. The well system as recited in claim 19, further including a sleeve of filler material placed within the control line tubular and the sleeve of expandable metal.

21. The well system as recited in claim 20, wherein the sleeve of filler material is positioned between the sleeve of expandable metal and the electric communication line or optical fiber communication line.

22. The well system as recited in claim 17, wherein the length (Lₜ) of the control line tubular is at least 4 cm, the width (Wₜ) of the control line tubular is no greater than 50 mm, and the wall thickness (Tₜ) of the control line tubular is no greater than 6 mm.

23. The well system as recited in claim 22, wherein the sleeve of expandable metal has a length (Lₛ) and wall thickness (Tₛ), and further wherein the length (Lₛ) is at least 3 cm, and the wall thickness (Tₛ) is no greater than 10 mm.

24. The well system as recited in claim 23, wherein the length (Lₛ) is at least 75% of the length (Lₜ).

25. The well system as recited in claim 23, wherein the length (Lₛ) is at least 90% of the length (Lₜ).

26. The well system as recited in claim 23, wherein the wall thickness (Tₛ) of the sleeve of expandable metal is no greater than 3 mm.

27. The well system a recited in claim 17, wherein the control line tubular forms at least a portion of a control line splice configured to couple two separate control lines together.
